(19) United States
(12) Patent Application Publication
(10) Pub. No.: US 2009/0159179 A1
(43) Pub. Date: Jun. 25, 2009

(54) METHOD OF MANUFACTURING MULTILAYER CERAMIC SUBSTRATE

(75) Inventors: Eun Tae Park, Yongin (KR); Min Ji Ko, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO.,LTD.

(21) Appl. No.: 12/340,039

(22) Filed: Dec. 19, 2008

(30) Foreign Application Priority Data
Dec. 20, 2007 (KR) 10-2007-0134580

(51) Int. Cl. C03B 29/00

(52) U.S. Cl. 156/89.11

(57) ABSTRACT

A method of manufacturing a multilayer ceramic substrate according to an aspect of the invention may include: manufacturing a ceramic laminate including a glass component; laminating constraining layers on upper and lower parts of the ceramic laminate; performing primary firing within a first temperature range that does not allow crystallization of the glass component included in the ceramic laminate; removing the constraining layers and forming an external electrode on the ceramic laminate after the primary firing is completed; and performing secondary firing of the ceramic laminate having the external electrode formed thereon within a second temperature range higher than the first temperature range.

### CROSS-REFERENCE TO RELATED APPLICATIONS

This application claims the priority of Korean Patent Application No. 2007-0134580 filed on Dec. 20, 2007, in the Korean Intellectual Property Office, the disclosure of which is incorporated herein by reference.

### BACKGROUND OF THE INVENTION

1. Field of the Invention

The present invention relates to a method of manufacturing a multilayer ceramic substrate, and more particularly, to a method of manufacturing a multilayer ceramic substrate that improves bonding strength between a ceramic laminate and an external electrode.

2. Description of the Related Art

As the growing trend towards a reduction in size of electronic components has been accelerated, small modules and substrates have been developed by precision-manufacturing, micro patterning, and thin-film construction of the electronic components. However, when generally used printed circuit boards (PCBs) are used in small-sized electronic components, disadvantages, such as a reduction in size, signal loss in the high frequency range, and a reduction in reliability at high-temperature and humidity, have been caused.

In order to overcome the above-described disadvantages, a substrate made from ceramic has been used instead of a PCB. The ceramic substrate is a ceramic composition containing much glass that allows low temperature co-firing.

A low temperature cofired ceramic (multilayer ceramic) substrate can be manufactured by using various kinds of methods. Among the methods, a shrinkage method and a non-shrinkage method are divided according to whether the ceramic substrate shrinks or not during firing. Specifically, in the shrink method, the ceramic substrate shrinks during a firing process. However, in the shrinkage method, since non-uniform shrinkage of the entire ceramic substrate occurs, a dimension change occurs along a plane direction of the substrate. The shrinkage of the ceramic substrate along the plane direction causes deformation of a printed circuit pattern included in the ceramic substrate. Therefore, degradation in position accuracy of the printed circuit pattern and a short circuit of the pattern may be caused. In order to solve the problems in the shrinkage method, the non-shrinkage method to prevent the shrinkage of the ceramic substrate along the plane direction during the firing process has been proposed.

According to the non-shrinkage method, constraining layers are formed on both surfaces of the ceramic substrate, and the ceramic substrate having the constraining layers formed thereon is fired. Here, the constraining layers may be formed of a material that does not shrink at a temperature where the ceramic substrate is fired and that is easily controlled in terms of shrinkage. The use of the constraining layers prevents the shrinkage of the ceramic substrate along the plane direction during the firing process but allows shrinkage along a thickness direction.

When the ceramic substrate shrinks during the firing process, the constraining layers are removed, external electrodes are formed, and then a re-firing process is performed to obtain bonding strength between the ceramic substrate and the external electrode. Here, the amount of glass remaining in the ceramic substrate may determine the bonding strength between the ceramic substrate and the external electrode. However, the glass components included in the ceramic substrate is crystallized during the firing process, and thus the amount of glass left in the substrate is significantly reduced. Therefore, even though the external electrode is formed on the ceramic substrate, and then the ceramic substrate having the external electrode formed thereon is re-fired, a significant decrease in bonding strength between the ceramic substrate and the external electrode may be caused.

### SUMMARY OF THE INVENTION

An aspect of the present invention provides a method of manufacturing a multilayer ceramic substrate that can improve bonding strength between a ceramic lamination and an external electrode during secondary firing by leaving a glass component by preventing crystallization of the glass component included in the ceramic laminate during primary firing.

According to an aspect of the present invention, there is provided a method of manufacturing a multilayer ceramic substrate, the method including: manufacturing a ceramic laminate including a glass component; laminating constraining layers on upper and lower parts of the ceramic laminate; performing primary firing within a first temperature range that does not allow crystallization of the glass component included in the ceramic laminate; removing the constraining layers and forming an external electrode on the ceramic laminate after the primary firing is completed; and performing secondary firing of the ceramic laminate having the external electrode formed thereon within a second temperature range higher than the first temperature range.

The first temperature range may be a temperature at which the ceramic laminate has a density of 90% or higher during the primary firing. The second temperature range may be a temperature at which the glass component is crystallized.

The glass component included in the ceramic laminate may be anorthite (CaAl₂Si₂O₈). The first temperature range may be a range of 830 to 850° C. The second temperature range may be higher than the first temperature range by 30 to 100° C.

The second temperature range may not cause damage to the external electrode.

The external electrode may be formed of anyone of copper, nickel, tungsten, titanium, chrome, vanadium, manganese, and molybdenum.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1C are vertical cross-sectional views illustrating a method of manufacturing a multilayer ceramic substrate according to an exemplary embodiment of the invention;

FIG. 2 is a graph illustrating the density of a ceramic substrate during primary firing according to an exemplary embodiment of the invention;

FIG. 3 is a graph showing measurement results of characteristics of multilayer ceramic substrates manufactured according to Inventive Example and Comparative Example; and

FIG. 4 is a graph showing measurement results of characteristics of multilayer ceramic substrates manufactured according to Inventive Example and Comparative Example.

### DETAILED DESCRIPTION OF THE PREFERRED EMBODIMENT

Exemplary embodiments of the present invention will now be described in detail with reference to the accompanying drawings.

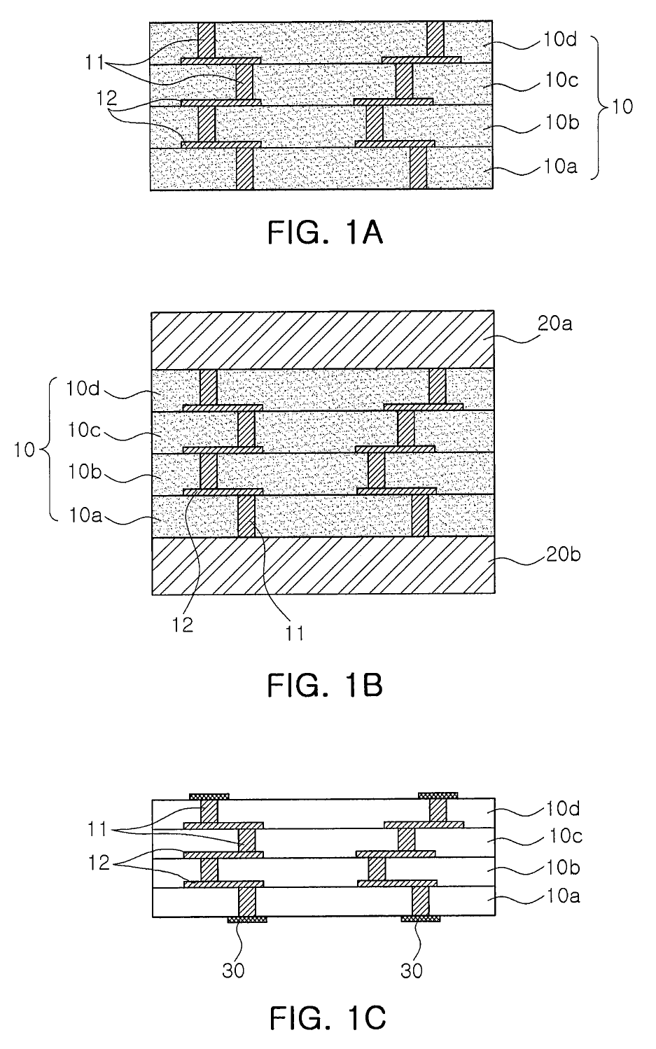

FIGS. 1A through 1C are vertical cross-sectional views illustrating a multilayer ceramic substrate according to an exemplary embodiment of the invention. Referring to FIG. 1A, a plurality of green sheets 10a, 10b, 10c, and 10d are laminated to form a ceramic laminate 10. Specifically, an acrylic binder is added at 15 wt %, a dispersant is added at 0.5 wt %, and a mixed solvent of toluene and ethanol is added to glass-ceramic powder of 100% to thereby form slurry. The slurry is applied and dried to provide one green sheet. A via hole 11 is formed at a predetermined position of the green sheet and then filled with a conductive paste. Then, an internal electrode 12 is formed on the surface of the green sheet by screen printing to form an internal circuit pattern. The plurality of green sheets 10a, 10b, 10c, and 10d that are formed by using the above-described method are laminated to form the ceramic laminate 10 shown in FIG. 1A.

Referring to FIG. 1B, constraining layers are laminated onto the ceramic laminate 10 manufactured in FIG. 1A, and a primary firing process is performed to fire the ceramic laminate 10 having the constraining layers laminated thereon. First, constraining layers 20a and 20b are formed. Here, a an acrylic binder is added at 15 wt %, a dispersant is added at 0.5 wt %, and a mixed solvent of toluene and ethanol is added to 100% alumina (Al₂O₃) powder having an average particle diameter of 1.5 μM to form slurry. The slurry is applied using a doctor blade method to form a constraining layer having a thickness of 100 μm. The formed constraining layers 20a and 20b are laminated onto upper and lower parts of the ceramic laminate 10, and a primary firing process is performed to fire the ceramic laminate 10 having the constraining layers 20a and 20b laminated thereon.

During the primary firing process, a first temperature range may be determined so that a material forming the ceramic laminate 10 shrinks and at the same time, a glass component is not crystallized. For example, when the glass components contained in the ceramic laminate 10 is anorthite (CaAl₂Si₂O₈), the ceramic laminate 10 may be primarily fired at a temperature lower than 850° C. at which the anorthite is not crystallized. Here, the firing temperature needs to be determined as 830° C. or higher in consideration of the shrinkage of the ceramic laminate 10. As a result, the first temperature range for the primary firing process can be determined within a range of 830 to 850° C. However, the first temperature range can be varied according to a firing temperature of the ceramic laminate 10 and a crystallinity temperature of the glass component.

As a result of the primary firing process, the ceramic laminate 10 shrinks and becomes dense, and at the same time, the glass component is not crystallized but remains in the ceramic laminate 10. Here, preferably, the ceramic laminate 10 has a density of 90% or higher.

Referring to FIG. 1C, a secondary firing process is performed to fire the ceramic laminate. After the primary firing process, shown in FIG. 1B, is completed, the constraining layers 20a and 20b are removed from the ceramic laminate 10, and external electrodes 30 are formed. Then, the ceramic laminate 10 having the external electrodes 30 formed thereon is fired within a second temperature range. Here, the second temperature range may be determined so that the glass component contained in the ceramic laminate 10 is crystallized. The second temperature range may be higher than the first temperature range for the primary firing process by approximately 30 to 100° C. In this embodiment, a temperature range of approximately 860 to 900° C. at which the anorthite, the glass component, is crystallized may be determined as the second temperature range. Therefore, the anorthite forming the ceramic laminate 10 is crystallized to improve the bonding strength between the ceramic laminate 10 and the external electrodes 30.

In this embodiment, copper, nickel, tungsten, titanium, chrome, vanadium, manganese, and molybdenum may be used as external electrode 30. These metals may not be damaged or deformed within the second temperature range.

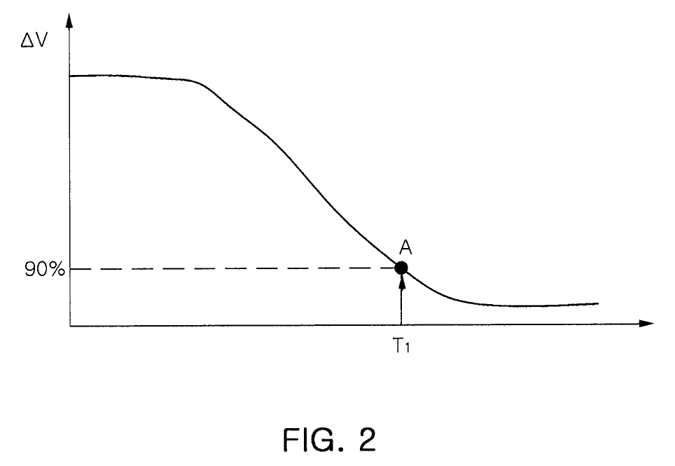

FIG. 2 is a graph illustrating the density of a ceramic laminate during a primary firing process according to an exemplary embodiment of the invention. As shown in FIG. 1B, the primary firing process is performed to fire the ceramic laminate 10 having the constraining layers 20a and 20b laminated thereon. Here, the first temperature range is applied to sinter the ceramic laminate 10. When the ceramic laminate 10 shrinks and becomes dense, the first temperature range may be determined as a temperature T1 of a point A where the density with respect to a volume change ^{Δ}V is 90% or higher, and the glass component is not crystallized. Further, the first temperature range T1 can be varied according to the firing temperature of ceramic powder forming the ceramic laminate 10 and a crystallinity temperature of the glass component.

Hereinafter, characteristics of a multilayer ceramic substrate manufactured according to Inventive Example and characteristics of a multilayer ceramic substrate manufactured according to Comparative Example to be described below were measured.

[Manufacturing Ceramic Substrate]

An acrylic binder was added at 15 wt %, a dispersant was added at 0.5 wt %, and a mixed solvent of toluene and ethanol was added to glass-ceramic powder of 100%, and the mixture was dispersed using a ball mill to form slurry. The slurry was filtered through a filter, deaerated, and formed into a green sheet having a thickness of 50 μm by using a doctor blade method. The green sheet was cut into a predetermined size, a predetermined electrode pattern was formed by screen printing, and fourteen layers of green sheets are pressed and laminated, thereby manufacturing an integrated non-sintered ceramic laminated.

[Forming Constraining Layer]

An acrylic binder was added at 15 wt %, a dispersant was added at 0.5 wt %, and a mixed solvent of toluene and ethanol was added to 100% glass-ceramic powder having an average particle diameter of 1.5 μm, and the mixture was dispersed using a ball mill to form slurry. The slurry was filtered using a filter, deaerated, and formed into a constraining layer having a thickness of 100 μm by using a doctor blade method.

[Primary Firing and Secondary Firing]

### Inventive Example

Temperature was increased up to 450° C. at a rate of 1° C. per minute to de-bind a ceramic laminate 10 having constraining layers 20a and 20b laminated thereon. The temperature was maintained for five hours. Then, temperature was increased from room temperature to 830° C. at a rate of 5° C. per minute, and then maintained for fifty minutes to perform a primary firing process. After the primary firing process was completed, the constraining layers 20a and 20b were removed from the ceramic laminate 10, and a conductive paste was formed on the ceramic laminate 10 by screen printing to form external electrodes 30. Then, temperature was increased from room temperature to 870° C. at a rate of 5° C. per minute, and then maintained for fifty minutes to perform a secondary firing process of the ceramic laminate 10 having the external electrodes 30 formed thereon.

### Comparative Example

Temperature was increased up to 450° C. at a rate of 1° C. per minute to de-bind the ceramic laminate 10 having constraining layers 20a and 20b laminated thereon. The temperature was maintained for five hours. Then, the temperature is increased at a rate of 5° C. per minute until it reaches 870° C., and then maintained for fifty minutes to perform a primary firing process. After the primary firing process is completed, the constraining layers 20a and 20b were removed from the ceramic laminate 10, and a conductive paste was formed on the ceramic laminate 10 by screen printing to form external electrodes 30. Then, temperature was increased at a rate of 5° C. per minute until it reaches 870° C., and then maintained for fifty minutes to perform a secondary firing process of the ceramic laminate 10 having the external electrodes 30 formed thereon.

<Evaluation>

(1) Change in Substrate Size

The size of the multilayer ceramic substrate manufactured according to Inventive Example and the size of the multilayered ceramic substrate manufactured according to Comparative Example were measured. The measurement data is shown in Table 1 below.

TABLE 1

| | Width after secondary | Change in sample |
|---|---|---|
| | firing [%] | dimension [%] |
| Inventive | −0.27 | 0.08 |
| example | | |
| Comparative | 0.23 | 0.19 |
| example | | |

Referring to Table 1, there is a difference of approximately 0.5% in width between the multilayer ceramic substrate manufactured according to Inventive Example in which the primary and secondary firing processes are performed at different firing temperatures from each other and the multilayer ceramic substrate manufactured according to Comparative Example in which the primary and secondary firing processes are performed at the same firing temperature. That is, the two multilayer ceramic substrates are little different in width. Further, there is little difference of approximately 0.11% in the change of sample dimension between the multilayer ceramic substrates.

(2) Change in Crystallinity

The crystallinity of the multilayer ceramic substrate manufactured according to Inventive Example and the crystallinity of the multilayer ceramic substrate manufactured according to Comparative Example were measured.

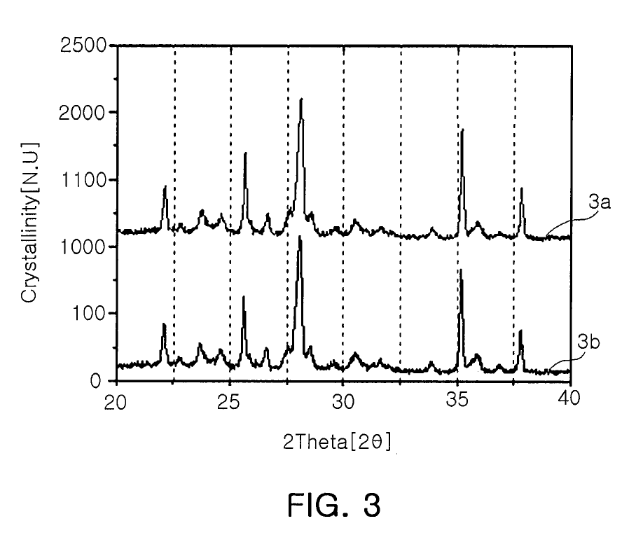

Referring to a measurement graph in FIG. 3, the crystallinity of the multilayer ceramic substrate manufactured according to Inventive Example in which the glass component is crystallized during the secondary firing process is shown in a first crystallinity graph 3a. The crystallinity of the multilayer ceramic substrate manufactured according to Comparative Example in which the glass component is crystallized during the primary firing process is shown in a second crystallinity graph 3b. It can be shown from the comparison between the first and second crystallinity graphs 3a and 3b that there is little difference in crystallinity between the multilayer ceramic substrates whether the glass component contained in the ceramic laminate 10 is crystallized during the primary or secondary firing process.

(3) Change in Bonding Strength Between Ceramic Laminate and External Electrode

Bonding strength of the multilayer ceramic substrate manufactured according to the Inventive Example and bonding strength of the multilayer ceramic substrate manufactured according to the Comparative Example were measured.

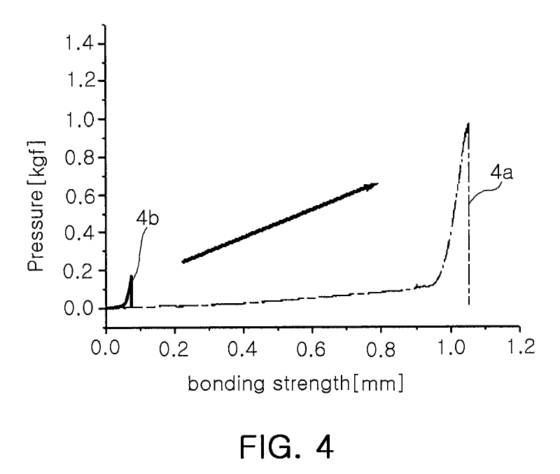

Referring to FIG. 4, the bonding strength between the external electrode 30 and the ceramic laminate 10 according to Inventive Example is shown in a first bonding strength graph 4a. The bonding strength between the external electrode 30 and the ceramic laminate 10 according to Comparative Example is shown in a second bonding strength graph 4b. It can be shown from the comparison between the first and second bonding strength graphs 4a and 4b that a higher bonding strength is obtained when the glass component is crystallized after the external electrode 30 is formed on the ceramic laminate 10 rather than when the glass component is crystallized during the primary firing process.

As shown in Table 1, FIG. 3, and FIG. 4, even when the glass component included in the ceramic laminate 10 is crystallized during the secondary firing process, this does not affect the size and the crystallinity of the multilayer ceramic substrate, and the bonding strength between the ceramic laminate 10 and the external electrode 30 can be improved.

As set forth above, according to an exemplary embodiment of the invention, the bonding strength between the ceramic laminate and the external electrode can be increased by crystallizing the glass component of the ceramic laminate after the external electrode is formed on the ceramic laminate.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing a multilayer ceramic substrate, the method comprising:
manufacturing a ceramic laminate including a glass component;
laminating constraining layers on upper and lower parts of the ceramic laminate;
performing primary firing within a first temperature range that does not allow crystallization of the glass component included in the ceramic laminate;
removing the constraining layers and forming an external electrode on the ceramic laminate after the primary firing is completed; and
performing secondary firing of the ceramic laminate having the external electrode formed thereon within a second temperature range higher than the first temperature range.

2. The method of claim 1, wherein the first temperature range is a temperature at which the ceramic laminate has a density of 90% or higher during the primary firing.

3. The method of claim 1, wherein the second temperature range is a temperature at which the glass component is crystallized.

4. The method of claim 1, wherein the glass component included in the ceramic laminate is anorthite (CaAl₂Si₂O₈).

5. The method of claim 4, wherein the first temperature range is a range of 830 to 850° C.

6. The method of claim 5, wherein the second temperature range is higher than the first temperature range by 30 to 100° C.

7. The method of claim 1, wherein the second temperature range does not cause damage to the external electrode.

8. The method of claim 1, wherein the external electrode is formed of any one of copper, nickel, tungsten, titanium, chrome, vanadium, manganese, and molybdenum.
